(19) United States
(12) Patent Application Publication
(10) Pub. No.: US 2025/0102033 A1
(43) Pub. Date: Mar. 27, 2025

(54) SCALEABLE FLAT IN-PLANE-MOTION MECHANICAL SPRING

(71) Applicant: Brigham Young University, Provo, UT (US)

(72) Inventors: Larry Howell, Provo, UT (US); Jacob Sheffield, Provo, UT (US); Brian Jensen, Provo, UT (US)

(73) Assignee: Brigham Young University, Provo, UT (US)

(21) Appl. No.: 18/523,330

(22) Filed: Nov. 29, 2023

Related U.S. Application Data
(60) Provisional application No. 63/540,138, filed on Sep. 25, 2023.

(51) Int. Cl. F16F 1/02; F41B 7/00

(52) U.S. Cl. CPC F16F 1/027; F41B 7/003

(57) ABSTRACT

A scalable flat in-plane-motion mechanical spring device. The device sincludes a frame with one or more flexures attached to the frame on a first end of the one or more flexures. The device further includes a shuttle with one or more of the one or more flexures attached to the shuttle on a second end of the one or more flexures. The frame, the shuttle, and the one or more flexures may be formed as a single piece.

### BACKGROUND

Springs have played a role in human subsistence throughout time and continue to do so. A cave painting in South Africa dated to be around 60,000 years old depicts the use of a bow, which is a type of spring. Early examples of springs were made from materials like wood, vines, and animal tendons. These were used for various purposes, such as traps, weapons, and simple mechanisms.

The ancient Greeks and Romans contributed to the development of springs in their mechanical designs and weapons. For example, the Greeks used coiled springs in some early clockwork mechanisms. The Romans used leaf springs in their chariots and springs in weapons of various types used in siege warfare. For example, springs were used in catapults such as ballista, scorpio, and onagers.

During the medieval and Renaissance periods, the technology of springs continued to evolve. Springs were used in various machines, including clocks and early firearms, to improve performance and precision. Torsion springs were used to launch projectiles. Scales and more complex locks used springs in their internal components.

The Industrial Revolution in the 18th and 19th centuries brought significant advancements in coil spring manufacturing. This period saw the widespread use of coil springs in industrial machinery, vehicles, and various mechanical devices. With the industrial revolution came the introduction of steel springs and the mass production of springs. Springs and elastic components were used in the design of suspension bridges to help absorb and distribute dynamic loads. These advancements in bridge engineering improved safety and allowed for the construction of longer and larger bridges. The development of highly accurate clock and watch springs improved the reliability and performance of timekeeping devices. The Industrial Revolution saw advancements in mechanical locks used in firearms by virtue of the use of spring powered trigger. Coil springs, flat springs, and other types were used in triggers, hammers, and other components, further enhancing firearm reliability and accuracy.

Today, in the modern era, springs are used in a multitude of applications, including industrial machinery, electronics, medical equipment, aerospace tools and components, and consumer products. Springs have also become an essential component in the development of various types of technology, such as the springs used in microelectromechanical systems (“MEMS”) and precision instruments. Advances in Materials science have led to the development of specialized materials for springs, including high-strength alloys and composite materials. Manufacturing techniques, such as computer-controlled wire forming and heat treatment processes, have improved the precision and performance of springs. Springs come in various forms, including coil springs, leaf springs, torsion springs, and gas springs, each designed for specific applications. The use of springs extends to everyday items like mattresses, ballpoint pens, and trampolines, as well as industrial machinery and aerospace technology.

One of the difficulties with the common coil spring, arguably the most widely used spring, is it is difficult to assemble within micro-mechanical instruments such as MEMS. As society begins to rely on smaller mechanical instruments the demand for smaller springs that are easy to assemble has increased. As space exploration increases the need for lightweight smaller equipment that includes smaller springs. Medical instruments and implants are in need of more compact components to minimalize invasive procedures. Moreover, when coil springs deflect, the end of the spring rotates relative to each other. This rotation can cause unwanted wear, vibration, and noise. It is the object of this disclosure to describe a scalable spring to meet the increasing demand for smaller mechanical components.

### SUMMARY OF THE DISCLOSURE

Disclosed herein is a scalable flat in-plane-motion mechanical spring device. The device includes a frame with one or more flexures attached to the frame on a first end of the one or more flexures. The device further includes a shuttle with one or more of the one or more flexures attached to the shuttle on a second end of the one or more flexures. The frame, the shuttle, and the one or more flexures may be formed as a single piece.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. The advantages of the disclosure will become better understood with regard to the following description and accompanying drawings where:

FIG. 1 illustrates a left-side view of a scalable flat in-plane-motion mechanical spring.

FIG. 2A illustrates a left-side view of an undeflected flat in-plane-motion mechanical spring.

FIG. 2B illustrates a left side view of a deflected scalable flat in-plane-motion mechanical spring.

FIG. 3 illustrates a left-side view of a scalable flat in-plane-motion mechanical spring.

FIG. 4A illustrates a left side view of an undeflected scalable flat in-plane-motion mechanical spring.

FIG. 4B illustrates a left side view of a deflected scalable flat in-plane-motion mechanical spring.

FIG. 5 illustrates a left side view of a undeflected scalable flat in-plane-motion mechanical spring.

FIG. 6 illustrates a left side view of a undeflected scalable flat in-plane-motion mechanical spring.

### DETAILED DESCRIPTION

In the following description of the disclosure, reference is made to the accompanying drawings, which form a part hereof, and in which are shown by way of illustration-specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure may be alternatively included in another embodiment or figure regardless of whether or not those elements are shown or described in another embodiment or figure. In other words, elements in the figures may be interchangeable between various embodiments disclosed herein, whether shown or not.

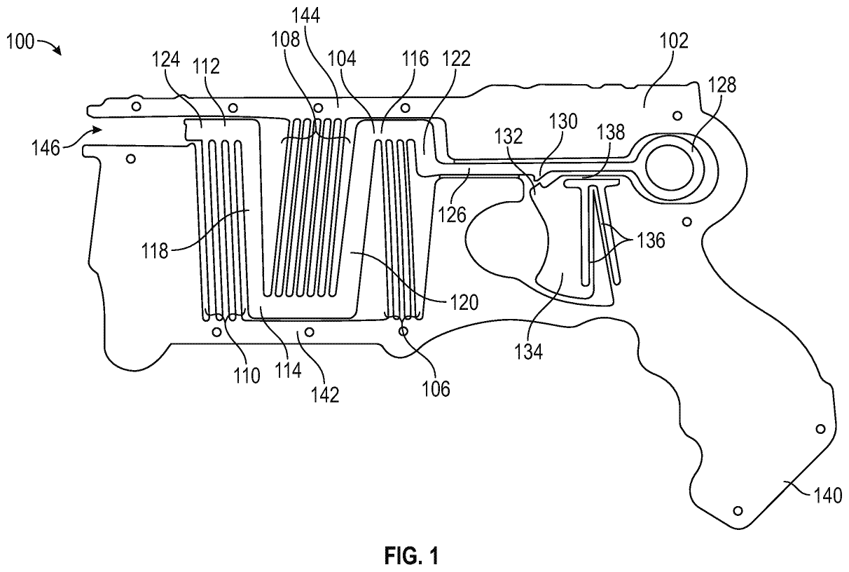

FIG. 1 illustrates a left-side view of scalable flat in-plane-motion mechanical spring 100 formed into a projectile shooting device. Flat in this context is defined as having a three-dimensional aspect that includes a length, width, and height. In-plane-motion in this context is defined to mean motion along the length and/or the height of spring 100. Herein, length is often described as distal and proximal, and height is often described as upper and lower. Further, spring 100 may include a substantially uniform width. The term “substantially” in this circumstance means plus or minus 1%. The length and height of spring 100 may exceed that of its width. Also, the flat three-dimensional nature of spring 100 is such that different portions of the spring 100 may not extend substantially beyond the plane defined by that length and the height of spring 100 with the exception of a projectile. The term “substantial” in this context means plus or minus 1%. Scaling of the spring constant of spring 100 may be done by changing the out-of-plane thickness, stacking springs 100 or similar springs, or stacking springs of various thicknesses.

Spring 100 may be a compliant mechanism and may be made of a single piece. Even though parts of spring 100 seem to behave independently from one another each part collectively may be formed as a single piece. Forming spring 100 as a single piece compliant mechanism may allow various two-dimensional manufacturing processes to manufacture spring 100. These manufacturing processes may include various computerized numerical control (“CNC”) machining including but not limited to CNC routing, CNC wire electrical discharge machining (“wire-EDM”), CNC waterjet cutting, CNC laser cutting, CNC plasma cutting, CNC milling, 2D milling. Manufacturing may include various types of 3D printing such as stereolithography (“SLA”), Selective Laser Sintering (“SLS”), Fused deposition modeling (“FDM”), multi-jet fusion (“MJF”), direct metal laser sintering (“DMLS”), electron beam melting (“EBM”), polyjet, etc., and other types of machining techniques known in the art. Alternatively, spring 100 may be made of multiple pieces. Furthermore, spring 100 may also be manufactured out of deoxyribonucleic acid (“DNA”) using DNA scaffold strands and DNA staples.

Other advantages of spring 100 being a compliant mechanism comprised of a single piece may include: a single piece weighs less than multiple pieces; a single piece requires no assembly; because there is a single piece and no assembly required it is less expensive; a single piece is more easily made by 3D printing or through CNC machining; and a single piece is more scalable because it requires no artificial joints which allow it to be more precise in its movements and creates less friction and other surface forces. Accordingly, the same geometry scales to different sizes without a change in stress given the same material or to materials with a similar strength-to-Young's modulus ratio.

Spring 100 may be used where other mechanical springs are used or where springs have been needed but have not had the appropriate dimensions space that now could be filled by spring 100. Spring 100 may be used to store energy like a mechanical battery. Since spring 100 may be scalable spring 100 may be used at a microscopic scale. For example, spring 100 may be used in one or more of the of the following: electrical connection ports to connect or disconnect items such as secure digital card; projectile launcher from mobile electronic equipment; valve actuation/controllers; control surface actuator such as one that may be used to open an emergency exit door on a plane; other doors in planes or vehicles such as overhead bins, glove compartments, fuel door to access a fuel port; pop-up books or birthday cards; hinges, locks and opening mechanisms found in doors and cabinetry; firearm mechanisms;

satellite or drone payload ejector; medical injector, implanter, and piercing device; wearable devices such as helmets, gloves coats, watches, jewelry; computers and gaming equipment; and other applications known in the art.

Additionally, spring 100 may include frame 102, shuttle 104, and one or more flexures 106, 108, and 110. Since spring 100 may be a compliant mechanism and may be comprised of a single piece frame 102 may entail portions of spring 100 that move and portions that have little or no movement. Also, frame 102 may extend around the outside edge of spring 100. Frame 102 may include various apertures near the outside edge to allow for points of attachment, fabrication, and/or weight distribution/reduction. Frame 102 may also include barrel aperture 146 which creates an opening in frame 102. A projectile may be placed within barrel aperture 146 that may receive propulsion energy transmitted through plunger 124 when actuated. Spring 100 may be implemented with something other than a projectile such as a syringe, or a needle to create an aperture or to sew a stitch, and/or it may be connectable to a switch that requires the force of spring 100 to actuate. Various types of implementations known in the art may be used. In other words, a projectile need not be required such that the movement of the shuttle 104 may produce its desired results.

One or more of flexures 106, 108, and 110 may be used in spring 100. Proximal flexures 106 and distal flexures 110 may attach to lower frame attachment section 142. Middle flexures 108 may attach to upper frame attachment section 144. Flexures 106, 108, and 110 may attach to frame attachment sections 142 or 144 with a first end and may attach to shuttle 104 with a second end. To illustrate proximal flexures 106 may attach to lower frame attachment section 142 at a first end. At a second end, proximal flexure 106 may attach to third horizontal section 116 of shuttle 104. The attachment of proximal flexure 106 to third horizontal section 116 in a resting or undeflected state may be set at a non-orthogonal angle from the length of horizontal section 116 such that the attachment at lower frame attachment section 142 is proximal to first horizontal section 116 of shuttle 104.

Similarly, distal flexures 110 may attach to lower frame attachment section 142 at a first end. At a second end, distal flexure 110 may attach to a first horizontal section 112 of shuttle 104. The attachment of distal flexure 110 to first horizontal section 112 in a resting or undeflected state may be set at a non-orthogonal angle such that the attachment at lower frame attachment section 142 is proximal to a first horizontal section 112 of shuttle 104. Middle flexures 108 may attach to upper frame attachment section 144 at a first end. At a second end, middle flexures 108 may attach to second horizontal section 114 of shuttle 104. The attachment of middle flexures 108 to second horizontal section 114 in a resting or undeflected state may set middle flexures 108 at an angle such that the first attachment to upper frame attachment section 144 may be positioned proximally to the second end attachment to second horizontal section 114 of shuttle 104. Flexures 106, 108, and 110 may include a plurality of flexures wherein one of flexures 106, 108, and 110 may include a number of flexures that differ in number from one or more of flexures 106, 108, and 110. For example, middle flexures 108 may include a plurality of flexures that differ in number of flexures from flexures found in one or more of flexures 110 and 106. Similarly, the number of flexures found in proximal flexures 106 may be different from one or more of flexures 108 and 110. The number of proximal flexures 106 combined with the number of distal flexures 110 may equal the number of middle flexures 108. This may provide equivalent or substantially equivalent stiffness on both sides of shuttle 104. The term substantially in this context mean plus or minus 5%.

Shuttle 104 may include plunger 124 attached to a first horizontal section 112. Since spring 100 may be implemented with something other than a projectile, as described above, plunger 124 may not be needed for spring 100 to function appropriately. First horizontal section 112 may attach to a first vertical section 118. First vertical section 118 may extend downward from first horizontal section 112 at an angle. First vertical section 118 may attach to second horizontal section 114 located near lower frame attachment 142. Second horizontal section 114 may attach to second vertical section 120. Second vertical section 120 may extend upward from second horizontal section 114 at an angle. Near upper frame attachment 144 second vertical section 120 may attach to third horizontal section 116. Third horizontal section 116 may attach to third vertical section 122. Third vertical section 122 may extend downward from third horizontal section 116 at an angle. Third horizontal section 122 may be sized differently than one or more of vertical sections 118 and 120. Third vertical section 122 may attach to fourth vertical section 126. Proximal to the attachment to third vertical section fourth horizontal section 126 may include hook 130. The size and length of horizontal sections 112, 114, 116, and 126 may differ in size or length as compared to one or more vertical sections 112, 114, 116, and 126. Similarly, vertical sections 118, 120, and 122 may differ in size or length as compared to one or more of vertical sections 118, 120, and 122. Additionally, vertical sections 118, and 120 may be largely mirror images of each other in length and angle. The term “substantially,” in this context, largely means plus or minus 5%. Proximal to hook 130 and attached to an end of fourth horizontal section 126 may be grip 128.

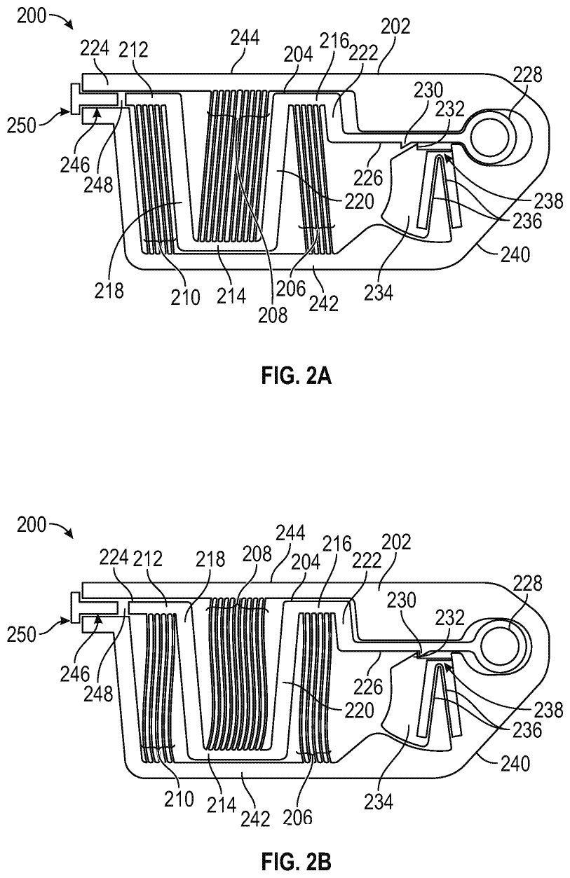

Grip 128 may provide a place where input force can be applied and can take the form of various connectors known in the art. Once an input force is applied to grip 128 pulling shuttle 104 proximally, hook 130 may interact with latch 132 locking shuttle 104 into a displaced position, as seen in FIG. 2B. Flexures 106, 108, and 110 may also be placed in a deflected position when shuttle 104 is locked into a displaced position. Shuttle 104 may be unlocked by pressure being applied to release 134. Release 134 may be attached to one or more flexures 136 and 138. Vertical release flexures 136 may be positioned at an angle respective to each other. Flexures 136 may facilitate the proximal and distal movement of release 134 such that the lower portion of release 134 moves more than the upper portion of release 134. Horizontal release flexure 138 may facilitate up and down movement of release 134 allowing hook 130 to slide into a locking position as input force is placed on grip 128. Proximally to horizontal release flexures 136 and below grip 128 is anchor 140. As part of frame 102, anchor 140 may be used to stabilize spring 100 to function in a particular direction. Anchor 140 is depicted as a handle but can be any item known in the art used to stabilize and direct the movement of spring 100.

FIG. 2A illustrates a left-side view of undeflected flat in-plane-motion mechanical spring 200. Flat in this context is defined as having a three-dimensional aspect that includes a length, width, and height. In-plane-motion in this context is defined to mean motion along the length and/or the height of spring 200. Herein, length is often described as distal and proximal, and height is often described as upper and lower. Further, spring 200 may include a substantially uniform width. The term “substantially.” In this circumstance, means plus or minus 1%. The length and height of spring 200 may exceed that of its width. Also, the flat three-dimensional nature of spring 200 is such that different portions of the spring 200 may not extend substantially beyond the plane defined by that length and the height of spring 200 with the exception of projectile 250. The term “substantial,” in this context, means plus or minus 1%. Scaling of the spring constant of spring 200 may be done by changing the out-of-plane thickness, stacking springs 200 or similar springs, or stacking springs of various thicknesses.

Spring 200 may be a compliant mechanism and may be made of a single piece. Even though parts of spring 200 seem to behave independently from one another each part collectively may be formed as a single piece. Forming spring 200 as a single piece compliant mechanism may allow various two-dimensional manufacturing processes to manufacture spring 200. These manufacturing processes may include various computerized numerical control (“CNC”) machining including but not limited to CNC routing, CNC wire electrical discharge machining (“wire-EDM”), CNC waterjet cutting, CNC laser cutting, CNC plasma cutting, CNC milling, 2D milling. Manufacturing may include various types of 3D printing such as stereolithography (“SLA”), Selective Laser Sintering (“SLS”), Fused deposition modeling (“FDM”), multi-jet fusion (“MJF”), direct metal laser sintering (“DMLS”), electron beam melting (“EBM”), polyjet, etc., and other types of machining known in the art. Alternatively, spring 200 may be made of multiple pieces. Furthermore, spring 200 may also be manufactured out of deoxyribonucleic acid (“DNA”) using DNA scaffold strands and DNA staples.

Other advantages of spring 200 being a compliant mechanism comprised of a single piece may include: a single piece weighs less than multiple pieces; a single piece requires no assembly; because there is a single piece and no assembly required it is less expensive; a single piece is more easily made by 3D printing or through CNC machining; and a single piece is more scalable because it requires no artificial joints which allow it to be more precise in its movements and creates less friction and other surface forces. Accordingly, the same geometry scales to different sizes without a change in stress given the same material or to materials with a similar strength-to-Young's modulus ratio.

Spring 200 may be used where other mechanical springs are used or where springs have been needed but have not had the appropriate dimensions space that now could be filled by spring 200. Spring 200 could be used to store energy like a mechanical battery. Since spring 200 may be scalable this spring 200 may be used at a microscopic scale. For example, spring 200 may be used in one or more of the of the following: electrical connection ports to connect or disconnect items such as secure digital card; projectile launcher from mobile electronic equipment; valve actuation/controllers; control surface actuator such as one that may be used to open an emergency exit door on a plane; other doors in planes or vehicles such as overhead bins, glove compartments, fuel door to access a fuel port; pop-up books or birthday cards; hinges, locks and opening mechanisms found in doors and cabinetry; firearm mechanisms; satellite or drone payload ejector; medical injector, implanter, and piercing device; wearable devices such as helmets, gloves coats, watches, jewelry; computers and gaming equipment; and other applications known in the art.

Spring 200 may include frame 202, shuttle 204, and one or more flexures 206, 208, and 210. Since spring 200 may be a compliant mechanism and may be comprised of a single piece frame 202 may entail portions of spring 200 that move and portions that have little or no movement. Also, frame 202 may extend around the outside edge of spring 200. Frame 202 may include various apertures near the outside edge to allow for points of attachment, fabrication, and/or weight distribution/reduction. Frame 202 may also include barrel aperture 246 which creates an opening in frame 202. Projectile 250 may be placed within barrel aperture 246 and may receive a propulsion energy transmitted through plunger 224 when actuated. Spring 200 may be implemented with something other than a projectile such as a syringe, or a needle to create an aperture or to sew a stitch, and/or it may be connectable to a switch that requires the force of spring 200 to actuate. Various types of implementations known in the art may be used. In other words, a projectile need not be required such that the movement of the shuttle 204 may produce its desired results.

One or more of flexures 206, 208, and 210 may be used in spring 200. Proximal flexures 206 and distal flexures 210 may attach to lower frame attachment section 242. Middle flexures 208 may attach to upper frame attachment section 244. Flexures 206, 208, and 210 may attach to frame attachment sections 242 or 244 with a first end and may attach to shuttle 204 with a second end. To illustrate proximal flexures 206 may attach to lower frame attachment section 242 at a first end. At a second end, proximal flexure 206 may attach to third horizontal section 216 of shuttle 204. This attachment in a resting or undeflected state may be set at a non-orthogonal angle such that the attachment at lower frame attachment section 242 is proximal to a first horizontal section 216 of shuttle 204.

Similarly, distal flexures 210 may attach to lower frame attachment section 242 at a first end. At a second end, proximal flexure 210 may attach to a first horizontal section 212 of shuttle 204. In a resting or undeflected state may be set at a non-orthogonal angle such that the attachment of flexure 210 at lower frame attachment section 242 is proximal to a first horizontal section 212 of shuttle 204. Middle flexures 208 may attach to upper frame attachment section 244 at a first end. At a second end, middle flexures 208 may attach to second horizontal section 214 of shuttle 204. In a resting or undeflected state may set middle flexures 208 at an angle such that the first attachment to upper frame attachment section 244 may be positioned proximally to the second end attachment to second horizontal section 214 of shuttle 204. Flexures 206, 208, and 210 may include a plurality of flexures wherein one of flexures 206, 208, and 210 may include a number of flexures that differ in number from one or more of flexures 206, 208, and 210. For example, middle flexures 208 may include a plurality of flexures that differ in number of flexures from flexures found in one or more of flexures 210 and 206. Similarly, the number of flexures found in proximal flexures 206 may be different from one or more of flexures 208 and 210. The number of proximal flexures 206 combined with the number of distal flexures 210 may equal the number of middle flexures 208. This may provide equivalent or substantially equivalent stiffness on both sides of shuttle 204. The term substantially in this context mean plus or minus 5%.

Shuttle 204 may include plunger 224 attached to first horizontal section 212. Since spring 200 may be implemented with something other than a projectile, as described above, plunger 224 may not be needed for spring 200 to function appropriately. First horizontal section 212 may attach to a first vertical section 218. First vertical section 218 may extend downward from first horizontal section 212 at an angle. First vertical section 218 may attach to second horizontal section 214 located near lower frame attachment 242. Second horizontal section 214 may attach to second vertical section 220. Second vertical section 220 may extend upward from second horizontal section 214 at an angle. Near upper frame attachment 244 second vertical section 220 may attach to third horizontal section 216. Third horizontal section 216 may attach to third vertical section 222. Third vertical section 222 may extend downward from third horizontal section 216 at an angle. Third horizontal section 222 may be sized differently than one or more of vertical sections 218 and 220. Third vertical section 222 may attach to fourth vertical section 226. Proximal to the attachment to third vertical section fourth horizontal section 226 may include hook 230. The size and length of horizontal sections 212, 214, 216, and 226 may differ in size or length as compared to one or more vertical sections 212, 214, 216, and 226. Similarly, vertical sections 218, 220, and 222 may differ in size or length as compared to one or more of vertical sections 218, 220, and 222. Additionally, vertical sections 218, and 220 may be largely mirror images of each other in length and angle. Substantially, in this context largely in this context is plus or minus 5%. Proximal to hook 230 and attached to an end of fourth horizontal section 226 may be grip 228.

Grip 228 may provide a place where input force can be applied and can take the form of various connectors known in the art. Once an input force is applied to grip 228 pulling shuttle 204 proximally, hook 230 may interact with latch 232 locking shuttle 204 into a displaced position, as seen in FIG. 2B. Flexures 206, 208, and 210 may also be placed in a deflected position when shuttle 204 is locked into a displaced position. Shuttle 204 may be unlocked by pressure being applied to release 234. Release 234 may be attached to one or more flexures 236 and 238. Vertical release flexures 236 may be positioned at an angle respective to each other. Flexures 236 may facilitate the proximal and distal movement of release 234 such that the lower portion of release 234 moves more than the upper portion of release 234. Horizontal release flexure 238 may facilitate up and down movement of release 234 allowing hook 230 to slide into a locking position as input force is placed on grip 228. Proximally to horizontal release flexures 236 and below grip 228 is anchor 240. As part of frame 202, anchor 240 may be used to stabilize spring 200 to function in a particular direction. Anchor 240 is depicted as a handle but can be any item known in the art used to stabilize and direct the movement of spring 200.

FIG. 2B illustrates a left side view of deflected scalable flat in-plane-motion mechanical spring 200. Spring 200 may include frame 202, shuttle 204, and one or more flexures 206, 208, and 210. Since spring 200 may be a compliant mechanism and may be comprised of a single piece frame 202 may entail portions of spring 200 that move and portions that have little or no movement. Also, frame 202 may extend around the outside edge of spring 200. Frame 202 may include various apertures near the outside edge to allow for points of attachment, fabrication, and/or weight distribution/reduction. Frame 202 may also include barrel aperture 246 which creates an opening in frame 202. Projectile 250 may be placed within barrel aperture 246 and may receive a propulsion energy transmitted through plunger 224 when actuated. Spring 200 may be implemented with something other than a projectile such as a syringe, or a needle to create an aperture or to sew a stitch, and/or it may be connectable to a switch that requires the force of spring 200 to actuate. Various types of implementations known in the art may be used. In other words, a projectile need not be required such that the movement of the shuttle 204 may produce its desired results.

One or more of flexures 206, 208, and 210 may be used in spring 200. Proximal flexures 206 and distal flexures 210 may attach to lower frame attachment section 242. Middle flexures 208 may attach to upper frame attachment section 244. Flexures 206, 208, and 210 may attach to frame attachment sections 242 or 244 at a first end and may attach to shuttle 204 at a second end. To illustrate proximal flexures 206 may attach to lower frame attachment section 242 at a first end. At a second end, proximal flexure 206 may attach to third horizontal section 216 of shuttle 204. This attachment in a resting or undeflected state may be set at a non-orthogonal angle such that the attachment at lower frame attachment section 242 is proximal to first horizontal section 216 of shuttle 204.

Similarly, distal flexures 210 may attach to lower frame attachment section 242 at a first end. At a second end, proximal flexure 210 may attach to a first horizontal section 212 of shuttle 204. This attachment in a resting or undeflected state may be set at a non-orthogonal angle such that the attachment at lower frame attachment section 242 is proximal to first horizontal section 212 of shuttle 204. Middle flexures 208 may attach to upper frame attachment section 244 at a first end. At a second end, middle flexures 208 may attach to second horizontal section 214 of shuttle 204. This attachment in a resting or undeflected state may set middle flexures 208 at an angle such that the first attachment to upper frame attachment section 244 may be positioned proximally to the second end attachment to second horizontal section 214 of shuttle 204 in a non-orthogonal manner. Flexures 206, 208, and 210 may include a plurality of flexures wherein one of flexures 206, 208, and 210 may include a number of flexures that differ in number from one or more of flexures 206, 208, and 210. For example, middle flexures 208 may include a plurality of flexures that differ in number of flexures from flexures found in one or more of flexures 210 and 206. Similarly, the number of flexures found in proximal flexures 206 may be different from one or more of flexures 208 and 210. The number of proximal flexures 206 combined with the number of distal flexures 210 may equal the number of middle flexures 208. This may provide equivalent or substantially equivalent stiffness on both sides of shuttle 204. The term substantially in this context mean plus or minus 5%.

Shuttle 204 may include plunger 224 attached to first horizontal section 212. Since spring 200 may be implemented with something other than a projectile, as described above, plunger 224 may not be needed for spring 200 to function appropriately. First horizontal section 212 may attach to a first vertical section 218. First vertical section 218 may extend downward from first horizontal section 212 at an angle. First vertical section 218 may attach to second horizontal section 214 located near lower frame attachment 242. Second horizontal section 214 may attach to second vertical section 220. Second vertical section 220 may extend upward from second horizontal section 214 at an angle. Near upper frame attachment 244 second vertical section 220 may attach to third horizontal section 216. Third horizontal section 216 may attach to third vertical section 222. Third vertical section 222 may extend downward from third horizontal section 216 at an angle. Third horizontal section 222 may be sized differently than one or more of vertical sections 218 and 220. Third vertical section 222 may attach to fourth vertical section 226. Proximal to the attachment to third vertical section fourth horizontal section 226 may include hook 230. The size and length of horizontal sections 212, 214, 216, and 226 may differ in size or length as compared to one or more vertical sections 212, 214, 216, and 226. Similarly, vertical sections 218, 220, and 222 may differ in size or length as compared to one or more of vertical sections 218, 220, and 222. Additionally, vertical sections 218, and 220 may be largely mirror images of each other in length and angle. The term “substantially,” in this context, is plus or minus 5%. Proximal to hook 230 and attached to an end of fourth horizontal section 226 may be grip 228.

Grip 228 may provide a place where input force can be applied and can take the form of various connectors known in the art. Once an input force is applied to grip 228 pulling shuttle 204 proximally, hook 230 may interact with latch 232 locking shuttle 204 into a displaced position. Flexures 206, 208, and 210 may also be placed in a deflected position when shuttle 204 is locked into a displaced position. Shuttle 204 may be unlocked by pressure being applied to release 234. Release 234 may be attached to one or more flexures 236 and 238. Vertical release flexures 236 may be positioned at an angle respective to each other. Flexures 236 may facilitate the proximal and distal movement of release 234 such that the lower portion of release 234 moves more than the upper portion of release 234. Horizontal release flexure 238 may facilitate up and down movement of release 234 allowing hook 230 to slide into a locking position as input force is placed on grip 228. Proximally to horizontal release flexures 236 and below grip 228 is anchor 240. As part of frame 202, anchor 240 may be used to stabilize spring 200 to function in a particular direction. Anchor 240 is depicted as a handle but can be any item known in the art used to stabilize and direct the movement of spring 200.

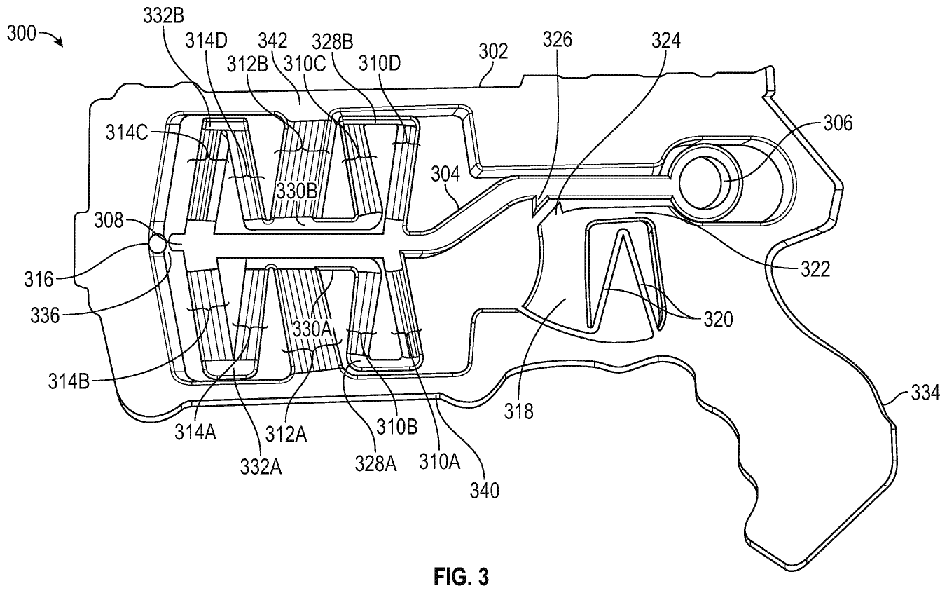

FIG. 3 illustrates a left-side view of scalable flat in-plane-motion mechanical spring 300 formed into a projectile shooting device. Flat in this context is defined as having a three-dimensional aspect that includes a length, width, and height. In-plane-motion in this context is defined to mean motion along the length and/or the height of spring 300. Herein, length is often described as distal and proximal, and height is often described as upper and lower. Further, spring 300 may include a substantially uniform width. The term “substantially,” in this circumstance, means plus or minus 1%. The length and height of spring 300 may exceed that of its width. Also, the flat three-dimensional nature of spring 300 is such that different portions of the spring 300 may not extend substantially beyond the plane defined by that length and the height of spring 300 with the exception of the projectile. The term “substantial,” in this context, means plus or minus 1%. Scaling of the spring constant of spring 300 may be done by changing the out-of-plane thickness, stacking springs 300 or similar springs, or stacking springs of various thicknesses.

Spring 300 may be a compliant mechanism and may be made of a single piece. Even though parts of spring 300 seem to behave independently from one another each part collectively may be formed as a single piece. Having spring 300 formed as a single piece compliant mechanism may allow various two-dimensional manufacturing processes to manufacture spring 300. These manufacturing processes may include various computerized numerical control (“CNC”) machining including but not limited to CNC routing, CNC wire electrical discharge machining (“wire-EDM”), CNC waterjet cutting, CNC laser cutting, CNC plasma cutting, CNC milling, 2D milling. Manufacturing may include various types of 3D printing such as stereolithography (“SLA”), Selective Laser Sintering (“SLS”), Fused deposition modeling (“FDM”), multi-jet fusion (“MJF”), direct metal laser sintering (“DMLS”), electron beam melting (“EBM”), polyjet, etc., and other types of machining known in the art. Alternatively, spring 300 may be made of multiple pieces. Furthermore, spring 300 may also be manufactured out of deoxyribonucleic acid (“DNA”) using DNA scaffold strands and DNA staples.

Other advantages of spring 300 being a compliant mechanism comprised of a single piece may include: a single piece weighs less than multiple pieces; a single piece requires no assembly; because there is a single piece and no assembly required it is less expensive; a single piece is more easily made by 3D printing or through CNC machining; and a single piece is more scalable because it requires no artificial joints which allow it to be more precise in its movements and creates less friction and other surface forces. Accordingly, the same geometry scales to different sizes without a change in stress given the same material or to materials with a similar strength-to-Young's modulus ratio.

Spring 300 may be used where other mechanical springs are used or where springs have been needed but have not heretofore been small enough to fit in places that could be filled by spring 300. Spring 300 could be used to store energy like a mechanical battery. Since spring 300 may be scalable this spring 300 may be used at a microscopic scale. For example, spring 300 may be used in one or more of the of the following: electrical connection ports to connect or disconnect items such as secure digital card; projectile launcher from mobile electronic equipment; valve actuation/controllers; control surface actuator such as one that may be used to open an emergency exit door on a plane; other doors in planes or vehicles such as overhead bins, glove compartments, fuel door to access a fuel port; pop-up books or birthday cards; hinges, locks and opening mechanisms found in doors and cabinetry; firearm mechanisms; satellite or drone payload ejector; medical injector, implanter, and piercing device; wearable devices such as helmets, gloves coats, watches, jewelry; computers and gaming equipment; and other applications known in the art.

Spring 300 may include frame 302, shuttle 304, and one or more flexures 310A-D, 312A-B, and 314A-D. Since spring 300 may be a compliant mechanism and may be formed as a single part, frame 302 may entail the portions of spring 300 that have little or no movement. Also, frame 302 may extend around the outside edge of spring 300. Frame 302 may also include barrel aperture 316 which creates an opening in frame 302. A projectile may be placed within barrel aperture 316 that may receive propulsion energy transmitted from an actuated spring 300 through plunger 308. Gap 336 may exist between a projectile and plunger 308 Spring 300 may be implemented with something other than a projectile such as a syringe, or a needle to create an aperture or to sew a stitch, and/or it may be connectable to a switch that requires the force of spring 300 to actuate. Various types of implementations known in the art may be used. In other words, a projectile need not be required such that the movement of the shuttle 304 may produce its desired results.

One or more of flexures 310A-D, 312A-B, and 314A-D may be used in spring 300. Flexures 310A-D, 312A-B, and 314A-D may attach to one or more of frame attachments 340 and 342, proximal spine 328A-B, middle spine 330A-B, and distal spine 332A-B. For example, the upper end of proximal flexures 310A may attach to the lower side of shuttle 304. The lower end of proximal flexures 310A may attach to a first end of lower proximal spine 328A. The upper end of proximal flexure 310B may attach to a first end of lower middle spine 330A. The lower end of proximal flexure 310B may attach to a second end of lower proximal spine 328A. Flexures 310A and 310B may be positioned such that at rest the upper ends of flexures 310A and 310 are closer in proximity than the bottom ends of flexures 310A and 310B.

The upper end of proximal flexures 310C may attach to a first end of upper proximal spine 328 and the lower end of proximal flexures 310C attach to a first end of the upper middle spine 330B. The upper end of proximal flexure 310D may attach to a second end of upper proximal spine 328. The lower end of proximal flexure 310D may attach to shuttle 304. The lower attachment of proximal flexure 310D may be positioned across the upper attachment of proximal flexure 310A across shuttle 304. Furthermore, the flexures attachments and positions above shuttle 304 may mirror attachments and positions below shuttle 304. The lower end of lower middle flexures 312A may attach to lower frame attachment 340. The upper end of lower middle flexures 312B may attach to the middle portion of lower middle spine 330A. The lower end of middle flexures 312B may attach to the middle portion of upper middle spine 330B. The upper end of middle flexures 312B may attach to upper frame attachment 342.

The upper end of distal flexure 314A may attach to a second end of lower middle spine 330A. The lower end of distal flexure 314A may attach to a first end of lower distal spine 332A, The upper end of distal flexure 314B may attach to the lower end of shuttle 304. The lower end of distal flexures 314B may attach to a second end of lower distal spine 332A. The upper end of distal flexures 314C may attach to a first end of upper distal spine 332B. The lower end of distal flexures 314C may attach to an upper end shuttle 304. The upper end of distal flexures 314D may attach to a second end of upper distal spine 332B. Spines 328A-B, 330A-B, and 332A-B may be free floating or may attach something equating to a back plate to anchor spines into position.

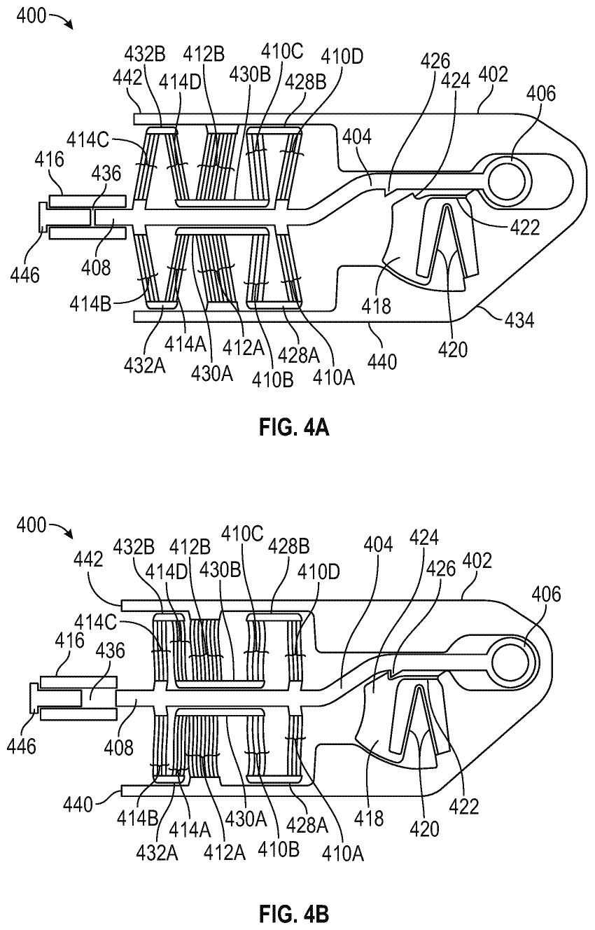

Grip 306 may provide a place where input force can be applied and can take the form of various connectors known in the art. Once an input force is applied to grip 306 pulling shuttle 304 proximally hook 326 may interact with latch 324 locking shuttle 304 into a displaced position, as seen in FIG. 4B. Flexures 310A-D, 312A-B, and 314A-D may also be placed in a deflected position when shuttle 304 is locked into a displaced position. Shuttle 304 may be unlocked by pressure being applied to release 318. Release 318 may be attached to one or more flexures 320 and 322. Vertical release flexures 320 may be positioned at a non-orthogonal angle respective to each other. Flexures 320 may facilitate the proximal and distal movement of release 318 such that the lower portion of release 318 moves more than the upper portion of release 318. Horizontal release flexure 322 may facilitate up and down movement of release 318 allowing hook 326 to slide into a locking position as input force is placed on grip 306. Proximally to horizontal release flexures 322 and below grip 306 is anchor 334. As part of frame 302, anchor 334 may be used to stabilize spring 300 to function in a particular direction. Anchor 334 can be any item known in the art used to stabilize and direct the movement of spring 300.

FIG. 4A illustrates a left side view of undeflected scalable flat in-plane-motion mechanical spring 400. Flat in this context is defined as having a three-dimensional aspect that includes a length, width, and height. In-plane-motion in this context is defined to mean motion along the length and/or the height of spring 400. Herein, length is often described as distal and proximal, and height is often described as upper and lower. Further, spring 400 may include a substantially uniform width. The term “substantially,” in this circumstance, means plus or minus 1%. The length and height of spring 400 may exceed that of its width. Also, the flat three-dimensional nature of spring 400 is such that different portions of the spring 400 may not extend substantially beyond the plane defined by that length and the height of spring 400 with the exception of projectile 446. The term “substantial.” in this context, means plus or minus 1%. Scaling of the spring constant of spring 400 may be done by changing the out-of-plane thickness, stacking springs 400 or similar springs, or stacking springs of various thicknesses. Spring 400 may be a compliant mechanism and may be formed as a single piece.

Even though parts of spring 400 seem to behave independently from one another each part collectively may be formed as a single piece. Forming spring 400 as a single piece compliant mechanism may allow various two-dimensional manufacturing processes to manufacture spring 400. These manufacturing processes may include various computerized numerical control (“CNC”) machining including but not limited to CNC routing, CNC wire electrical discharge machining (“wire-EDM”), CNC waterjet cutting, CNC laser cutting, CNC plasma cutting, CNC milling, 2D milling. Manufacturing may include various types of 3D printing such as stereolithography (“SLA”), Selective Laser Sintering (“SLS”), Fused deposition modeling (“FDM”), multi-jet fusion (“MJF”), direct metal laser sintering (“DMLS”), electron beam melting (“EBM”), polyjet, etc., and other types of machining known in the art. Alternatively, spring 400 may be made of multiple pieces. Furthermore, spring 400 may also be manufactured out of deoxyribonucleic acid (“DNA”) using DNA scaffold strands and DNA staples.

Other advantages of spring 400 being a compliant mechanism formed as a single piece may include: a single piece weighs less than multiple pieces; a single piece requires no assembly; because there is a single piece and no assembly required it is less expensive; a single piece is more easily made by 3D printing or through CNC machining; and a single piece is more scalable because it requires no artificial joints which allow it to be more precise in its movements and creates less friction and other surface forces. Accordingly, the same geometry scales to different sizes without a change in stress given the same material or to materials with a similar strength-to-Young's modulus ratio.

Spring 400 may be used where other mechanical springs are used or where springs have been needed but have not heretofore been small enough to be installed in spaces that may be appropriate for spring 400. Spring 400 could be used to store energy like a mechanical battery. Since spring 400 may be scalable this spring 400 may be used at a microscopic scale. For example, spring 400 may be used in one or more of the of the following: electrical connection ports to connect or disconnect items such as secure digital card; projectile launcher from mobile electronic equipment; valve actuation/controllers; control surface actuator such as one that may be used to open an emergency exit door on a plane; other doors in planes or vehicles such as overhead bins, glove compartments, fuel door to access a fuel port; pop-up books or birthday cards; hinges, locks and opening mechanisms found in doors and cabinetry; firearm mechanisms; satellite or drone payload ejector; medical injector, implanter, and piercing device; wearable devices such as helmets, gloves coats, watches, jewelry; computers and gaming equipment; and other applications known in the art.

Spring 400 may include frame 402, shuttle 404, and one or more flexures 410A-D, 412A-B, and 414A-D. Since spring 400 may be a compliant mechanism and may be formed as a single part, frame 402 may entail the portions of spring 400 that have little or no movement. Also, frame 402 may extend around the outside edge of spring 400. Frame 402 may also include barrel aperture 416 which creates an opening in frame 402. Projectile 446 may be placed within barrel aperture 416 that may receive propulsion energy transmitted from an actuated spring 400 through plunger 408. Gap 436 may exist between projectile 446 and plunger 408. Spring 400 may be implemented with something other than a projectile such as a syringe, or a needle to create an aperture or to sew a stitch, and/or it may be connectable to a switch that requires the force of spring 400 to actuate. Various types of implementations known in the art may be used. In other words, a projectile need not be required such that the movement of the shuttle 404 may produce its desired results.

One or more of flexures 410A-D, 412A-B, and 414A-D may be used in spring 400. Flexures 410A-D, 412A-B, and 414A-D may attach to one or more of frame attachments 440 and 442, proximal spine 428A-B, middle spine 430A-B, and distal spine 432A-B. For example, the upper end of proximal flexures 410A may attach to the lower side of shuttle 404. The lower end of proximal flexures 410A may attach to a first end of lower proximal spine 428A. The upper end of proximal flexure 410B may attach to a first end of lower middle spine 430A. The lower end of proximal flexure 410B may attach to a second end of lower proximal spine 428A. Flexures 410A and 410B may be positioned such that at rest the upper ends of flexures 410A and 410 are closer in proximity than the bottom ends of flexures 410A and 410B.

The upper end of proximal flexures 410C may attach to a first end of upper proximal spine 428 and the lower end of proximal flexures 410C attach to a first end of the upper middle spine 430B. The upper end of proximal flexure 410D may attach to a second end of upper proximal spine 428. The lower end of proximal flexure 410D may attach to shuttle 404. The lower attachment of proximal flexure 410D may be positioned across the upper attachment of proximal flexure 410A across shuttle 404. Furthermore, the flexures attachments and positions above shuttle 404 may mirror attachments and positions below shuttle 404. The lower end of lower middle flexures 412A may attach to lower frame attachment 440. The upper end of lower middle flexures 412B may attach to the middle portion of lower middle spine 430A. The lower end of middle flexures 412B may attach to the middle portion of upper middle spine 430B. The upper end of middle flexures 412B may attach to upper frame attachment 442.

The upper end of distal flexure 414A may attach to a second end of lower middle spine 430A. The lower end of distal flexure 414A may attach to a first end of lower distal spine 432A. The upper end of distal flexure 414B may attach to the lower end of shuttle 404. The lower end of distal flexures 414B may attach to a second end of lower distal spine 432A. The upper end of distal flexures 414C may attach to a first end of upper distal spine 432B. The lower end of distal flexures 414C may attach to an upper end shuttle 404. The upper end of distal flexures 414D may attach to a second end of upper distal spine 432B. Spines 428A-B, 430A-B, and 432A-B may be free floating or may attach something equating to a back plate to anchor spines into position.

Grip 406 may provide a place where input force can be applied and can take the form of various connectors known in the art. Once an input force is applied to grip 406 pulling shuttle 404 proximally hook 426 may interact with latch 424 locking shuttle 404 into a displaced position, as seen in FIG. 4B. Flexures 410A-D, 412A-B, and 414A-D may also be placed in a deflected position when shuttle 404 is locked into a displaced position. Shuttle 404 may be unlocked by pressure being applied to release 418. Release 418 may be attached to one or more flexures 420 and 422. Vertical release flexures 420 may be positioned at an angle respective to each other. Flexures 420 may facilitate the proximal and distal movement of release 418 such that the lower portion of release 418 moves more than the upper portion of release 418. Horizontal release flexure 422 may facilitate up and down movement of release 418 allowing hook 426 to slide into a locking position as input force is placed on grip 406. Proximally to horizontal release flexures 422 and below grip 406 is anchor 434. As part of frame 402, anchor 434 may be used to stabilize spring 400 to function in a particular direction. Anchor 434 can be any item known in the art used to stabilize and direct the movement of spring 400.

FIG. 4B illustrates a left side view of deflected scalable flat in-plane-motion mechanical spring 400. Spring 400 may include frame 402, shuttle 404, and one or more flexures 410A-D, 412A-B, and 414A-D. Since spring 400 may be a compliant mechanism and may be formed as a single part, frame 402 may entail the portions of spring 400 that have little or no movement. Also, frame 402 may extend around the outside edge of spring 400. Frame 402 may also include barrel aperture 416 which creates an opening in frame 402. Projectile 446 may be placed within barrel aperture 416 and may receive propulsion energy transmitted from an actuated spring 400 through plunger 408. Gap 436 may exist between projectile 446 and plunger 408. Spring 400 may be implemented with something other than a projectile such as a syringe, or a needle to create an aperture or to sew a stitch, and/or it may be connectable to a switch that requires the force of spring 400 to actuate. Various types of implementations known in the art may be used. In other words, a projectile need not be required such that the movement of the shuttle 404 may produce its desired results.

One or more of flexures 410A-D, 412A-B, and 414A-D may be used in spring 400. Flexures 410A-D, 412A-B, and 414A-D may attach to one or more of frame attachments 440 and 442, proximal spine 428A-B, middle spine 430A-B, and distal spine 432A-B. For example, the upper end of proximal flexures 410A may attach to the lower side of shuttle 404. The lower end of proximal flexures 410A may attach to a first end of lower proximal spine 428A. The upper end of proximal flexure 410B may attach to a first end of lower middle spine 430A. The lower end of proximal flexure 410B may attach to a second end of lower proximal spine 428A. Flexures 410A and 410B may be positioned such that at rest the upper ends of flexures 410A and 410 are closer in proximity than the bottom ends of flexures 410A and 410B.

The upper end of proximal flexures 410C may attach to a first end of upper proximal spine 428 and the lower end of proximal flexures 410C attach to a first end of the upper middle spine 430B. The upper end of proximal flexure 410D may attach to a second end of upper proximal spine 428. The lower end of proximal flexure 410D may attach to shuttle 404. The lower attachment of proximal flexure 410D may be positioned across the upper attachment of proximal flexure 410A across shuttle 404. Furthermore, the flexures attachments and positions above shuttle 404 may mirror attachments and positions below shuttle 404. The lower end of lower middle flexures 412A may attach to lower frame attachment 440. The upper end of lower middle flexures 412B may attach to the middle portion of lower middle spine 430A. The lower end of middle flexures 412B may attach to the middle portion of upper middle spine 430B. The upper end of middle flexures 412B may attach to upper frame attachment 442.

The upper end of distal flexure 414A may attach to a second end of lower middle spine 430A. The lower end of distal flexure 414A may attach to a first end of lower distal spine 432A. The upper end of distal flexure 414B may attach to the lower end of shuttle 404. The lower end of distal flexures 414B may attach to a second end of lower distal spine 432A. The upper end of distal flexures 414C may attach to a first end of upper distal spine 432B. The lower end of distal flexures 414C may attach to an upper end shuttle 404. The upper end of distal flexures 414D may attach to a second end of upper distal spine 432B.

Grip 406 may provide a place where input force can be applied and can take the form of various connectors known in the art. Once an input force is applied to grip 406 pulling shuttle 404 proximally hook 426 may interact with latch 424 locking shuttle 404 into a displaced position, as seen in FIG. 4B. Flexures 410A-D, 412A-B, and 414A-D may also be placed in a deflected position when shuttle 404 is locked into a displaced position. Shuttle 404 may be unlocked by pressure being applied to release 418. Release 418 may be attached to one or more flexures 420 and 422. Vertical release flexures 420 may be positioned at an angle respective to each other. Flexures 420 may facilitate the proximal and distal movement of release 418 such that the lower portion of release 418 moves more than the upper portion of release 418. Horizontal release flexure 422 may facilitate up and down movement of release 418 allowing hook 426 to slide into a locking position as input force is placed on grip 406. Proximally to horizontal release flexures 422 and below grip 406 is anchor 434. As part of frame 402, anchor 434 may be used to stabilize spring 400 to function in a particular direction. Anchor 434 can be any item known in the art used to stabilize and direct the movement of spring 400.

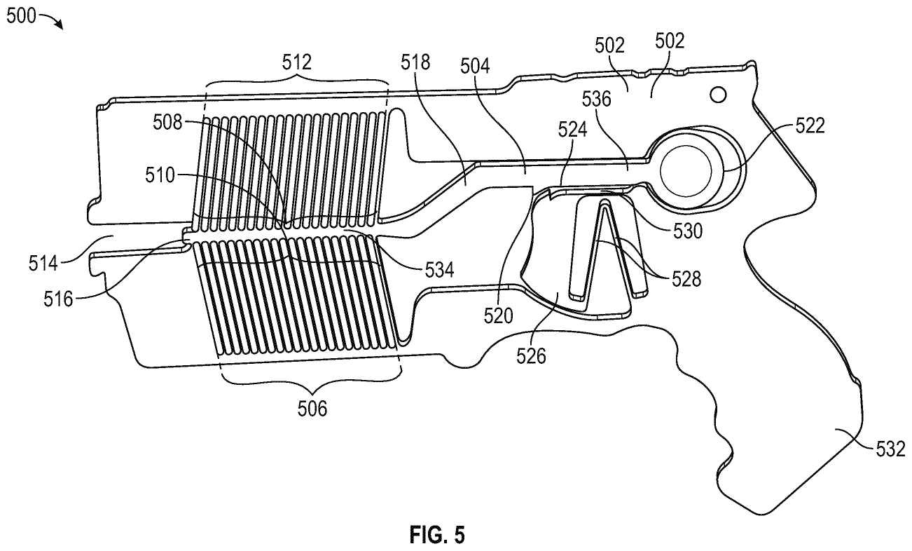

FIG. 5 illustrates a left side view of a undeflected scalable flat in-plane-motion mechanical spring 500 formed into a projectile shooting device. Flat in this context is defined as having a three-dimensional aspect that includes a length, width, and height. In-plane-motion in this context is defined to mean motion along the length and/or the height of spring 500. Herein, length is often described as distal and proximal, and height is often described as upper and lower. Further, spring 500 may include a substantially uniform width. The term “substantially,” in this circumstance, means plus or minus 1%. The length and height of spring 500 may exceed that of its width. Also, the flat three-dimensional nature of spring 500 is such that different portions of the spring 500 may not extend substantially beyond the plane defined by that length and the height of spring 500 with the exception of a projectile. The term “substantial,” in this context means plus or minus 1%. Scaling of the spring constant of spring 500 may be done by changing the out-of-plane thickness, stacking springs 500 or similar springs, or stacking springs of various thicknesses.

Spring 500 may be a compliant mechanism and may be made of a single piece. Even though parts of spring 500 seem to behave independently from one another each part collectively may be formed as a single piece. Forming spring 500 as a single piece compliant mechanism may allow various two-dimensional manufacturing processes to manufacture spring 500. These manufacturing processes may include various computerized numerical control (“CNC”) machining including but not limited to CNC routing, CNC wire electrical discharge machining (“wire-EDM”), CNC waterjet cutting, CNC laser cutting, CNC plasma cutting, CNC milling, 2D milling. Manufacturing may include various types of 3D printing such as stereolithography (“SLA”), Selective Laser Sintering (“SLS”), Fused deposition modeling (“FDM”), multi-jet fusion (“MJF”), direct metal laser sintering (“DMLS”), electron beam melting (“EBM”), polyjet, etc., and other types of machining known in the art. Alternatively, spring 500 may be made of multiple pieces. Furthermore, spring 500 may also be manufactured out of deoxyribonucleic acid (“DNA”) using DNA scaffold strands and DNA staples.

Other advantages of spring 500 being a compliant mechanism comprised of a single piece may include: a single piece weighs less than multiple pieces; a single piece requires no assembly; because there is a single piece and no assembly required it is less expensive; a single piece is more easily made by 3D printing or through CNC machining; and a single piece is more scalable because it requires no artificial joints which allow it to be more precise in its movements and creates less friction and other surface forces. Accordingly, the same geometry scales to different sizes without a change in stress given the same material or to materials with a similar strength-to-Young's modulus ratio.

Spring 500 may be used where other mechanical springs are used or where springs have been needed but have heretofore been small enough to be installed in spaces that may be appropriate for spring 500. Spring 500 me be used to store energy like a mechanical battery. Since spring 500 may be scalable, spring 500 may be used at a microscopic scale. For example, spring 500 may be used in one or more of the of the following: electrical connection ports to connect or disconnect items such as secure digital card; projectile launcher from mobile electronic equipment; valve actuation/controllers; control surface actuator such as one that may be used to open an emergency exit door on a plane; other doors in planes or vehicles such as overhead bins, glove compartments, fuel doors to access a fuel port; pop-up books or birthday cards; hinges, locks and opening mechanisms found in doors and cabinetry; firearm mechanisms; satellite or drone payload ejector; medical injector, implanter, and piercing device; wearable devices such as helmets, gloves coats, watches, jewelry; computers and gaming equipment; and other applications known in the art.

Spring 500 may include frame 502, shuttle 504, and one or more flexures 508 and 510. Since spring 500 may be a compliant mechanism and may be formed as a single piece frame 502 may entail portions of spring 500 that move and portions that have little or no movement. Also, frame 502 may extend around the outside edge of spring 500. Frame 502 may include various apertures near the outside edge to allow for points of attachment, fabrication, and/or weight distribution/reduction. Frame 502 may also include barrel aperture 514 which creates an opening in frame 502. A projectile may be placed within barrel aperture 514 that may receive propulsion energy transmitted through plunger 516 when actuated. Spring 500 may be implemented with something other than a projectile such as a syringe, or a needle to create an aperture or to sew a stitch, and/or it may be connectable to a switch that requires the force of spring 500 to actuate. Various types of implementations known in the art may be used. In other words, a projectile need not be required such that the movement of the shuttle 504 may produce its desired results.

One or more of flexures 508 and 510 may be used in spring 500. The bottom ends of upper flexures 508 may attach to the upper side of distal shuttle section 534 of shuttle 504. The top ends of flexures 508 may attach to frame attachment site 512. The bottom ends of lower flexures 510 may to frame attachment site 506. The top ends of lower flexure 510 may attach to the bottom side distal shuttle section 534 of shuttle 504. In an undeflected state, flexures 508 and 510 may set at a non-orthogonal angle such that flexures 508 and 510 attachment to their respective frame attachment sites 506 and 512 is more proximal than the attachment of flexures 508 and 510 to the distal section of 534 of shuttle 504. Further, flexures 508, from top to bottom may be a mirror image of flexures 510. Though not depicted spring 500 flexures 508 and S10 may behave similarly to flexures 410A-D, 412A-B, 414A-D in FIG. 4B and similar to flexures 206, 208, and 210 in FIG. 2B. Accordingly, flexures in a deflected state will be position in bending position storing potential energy to be released.

Shuttle 504 may include plunger 516 attached to a distal section 534 of shuttle 504. Since spring 500 may be implemented with something other than a projectile, as described above, plunger 516 may not be needed for spring 500 to function appropriately. Distal section 534 may attach to middle section 518 that may angle upwards towards proximal section 536 of shuttle 504 where it attaches to proximal section 536. Proximal section 536 of shuttle 504 may include hook 520 sized to attach to latch 524. At the proximal end of proximal section 536 may be grip 522. Grip 522 may provide a place where input force can be applied and can take the form of various connectors known in the art. Once an input force is applied to grip 522 pulling shuttle 504 proximally, hook 520 may interact with latch 524 locking shuttle 504 into a displaced position, as seen in FIGS. 2B and 4B. Flexures 508 and 510 may also be placed in a deflected position when shuttle 504 is locked into a displaced position. Shuttle 504 may be unlocked by pressure being applied to release 526. Release 526 may be attached to one or more flexures 528 and 530. Vertical release flexures 528 may be positioned at an angle respective to each other. Vertical release flexures 528 may facilitate the proximal and distal movement of release 526 such that the lower portion of release 526 moves more than the upper portion of release 526. Horizontal release flexure 530 may facilitate up and down movement of release 526 allowing hook 520 to slide into a locking position as input force is placed on grip 522. Proximally to horizontal release flexures 528 and below grip 522 may be anchor 532. As part of frame 502, anchor 532 may be used to stabilize spring 500 to function in a particular direction. Anchor 540 is depicted as a handle but can be any item known in the art used to stabilize and direct the movement of spring 500. Alternatively, spring 500 may be secured in place by various method know in the art including and not including anchor 532.

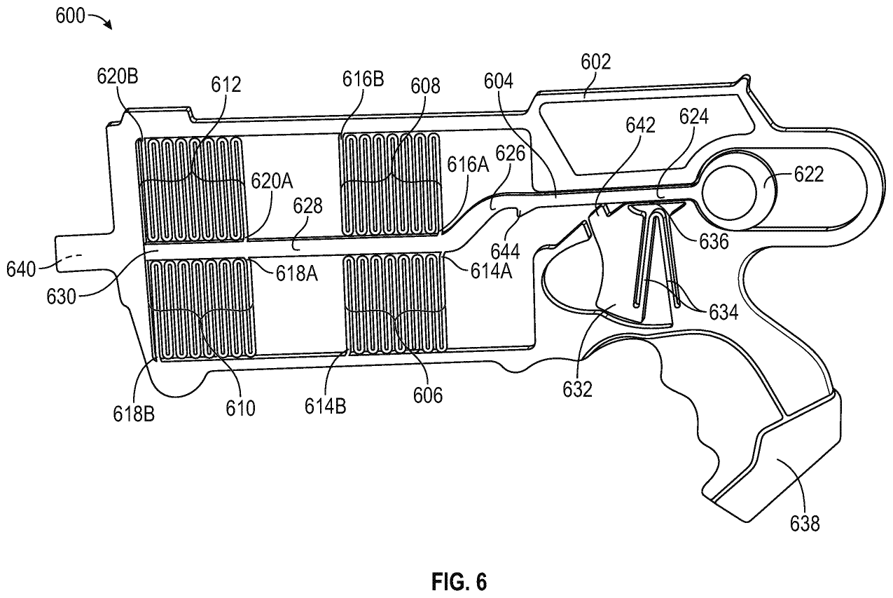

FIG. 6 illustrates a left side view of undeflected scalable flat in-plane-motion mechanical spring 600 formed into a projectile shooting device. Flat in this context is defined as having a three-dimensional aspect that includes a length, width, and height. In-plane-motion in this context is defined to mean motion along the length and/or the height of spring 600. Herein, length is often described as distal and proximal, and height is often described as upper and lower. Further, spring 600 may include a substantially uniform width. The term “substantially,” in this circumstance means plus or minus 1%. The length and height of spring 600 may exceed that of its width. Also, the flat three-dimensional nature of spring 600 is such that different portions of the spring 600 may not extend substantially beyond the plane defined by that length and the height of spring 600 with the exception of a projectile. The term “substantial,” in this context means plus or minus 1%. Scaling of the spring constant of spring 600 may be done by changing the out-of-plane thickness, stacking springs 600 or similar springs, or stacking springs of various thicknesses

Spring 600 may be a compliant mechanism and may be made of a single piece. Even though parts of spring 600 seem to behave independently from one another each part collectively may be formed as a single piece. Having spring 400 comprised of a single piece compliant mechanism may allow various two-dimensional manufacturing processes to manufacture spring 600. These manufacturing processes may include various computerized numerical control (“CNC”) machining including but not limited to CNC routing, CNC wire electrical discharge machining (“wire-EDM”), CNC waterjet cutting, CNC laser cutting, CNC plasma cutting, CNC milling, 2D milling. Manufacturing may include various types of 3D printing such as stereolithography (“SLA”), Selective Laser Sintering (“SLS”), Fused deposition modeling (“FDM”), multi-jet fusion (“MJF”), direct metal laser sintering (“DMLS”), electron beam melting (“EBM”), polyjet, etc., and other types of machining known in the art.

Alternatively, spring 600 may be made of multiple pieces. Furthermore, spring 600 may also be manufactured out of deoxyribonucleic acid (“DNA”) using DNA scaffold strands and DNA staples.

Other advantages of spring 600 being a compliant mechanism comprised of a single piece may include: a single piece weighs less than multiple pieces; a single piece requires no assembly; because there is a single piece and no assembly required it is less expensive; a single piece is more easily made by 3D printing or through CNC machining; and a single piece is more scalable because it requires no artificial joints which allow it to be more precise in its movements and creates less friction and other surface forces. Accordingly, the same geometry scales to different sizes without a change in stress given the same material or to materials with a similar strength-to-Young's modulus ratio.

Spring 600 may be used where other mechanical springs are used or where springs have been needed but have not had the appropriate dimensions space that now could be filled by spring 600. Spring 600 could be used to store energy like a mechanical battery. Since spring 600 may be scalable this spring 600 may be used at a microscopic scale. For example, spring 300 may be used in one or more of the of the following: electrical connection ports to connect or disconnect items such as secure digital card; projectile launcher from mobile electronic equipment; valve actuation/controllers; control surface actuator such as one that may be used to open an emergency exit door on a plane; other doors in planes or vehicles such as overhead bins, glove compartments, fuel doors to access a fuel port; pop-up books or birthday cards; hinges, locks and opening mechanisms found in doors and cabinetry; firearm mechanisms; satellite or drone payload ejector; medical injector, implanter, and piercing device; wearable devices such as helmets, gloves coats, watches, jewelry; computers and gaming equipment; and other applications known in the art.

Spring 600 may include frame 602, shuttle 604, and one or more flexures 606, 608, 610, and 612. Since spring 600 may be a compliant mechanism and may be comprised of a single piece frame 602 may entail portions of spring 600 that move and portions that have little or no movement. Also, frame 602 may extend around the outside edge of spring 600. Frame 602 may include various apertures near the outside edge to allow for points of attachment, fabrication, and/or weight distribution/reduction. Frame 602 may also include barrel aperture 640 which creates an opening in frame 602. A projectile may be placed within barrel aperture 640 that may receive propulsion energy transmitted through plunger 630 when actuated. Spring 600 may be implemented with something other than a projectile such as a syringe, or a needle to create an aperture or to sew a stitch, and/or it may be connectable to a switch that requires the force of spring 600 to actuate. Various types of implementations known in the art may be used. In other words, a projectile need not be required such that the movement of the shuttle 604 may produce its desired results.

One or more of flexures 606, 608, 610 and 612 may be used in spring 600. Flexure 606 may attach to distal section 628 of shuttle 604 at attachment point 614A and attach to frame 602 at attachment point 614B. Attachment 614A may be located proximally to attachment 614B and flexure 606 may be an accordion shaped such that when deflected the flexure spreads out proximally as the shuttle 604 is pulled to the proximal end. Flexure 608 may attach to distal section 628 of shuttle 604 at attachment point 616A and attach to frame 602 at attachment point 616B. Attachment 616A may be located proximally to attachment 616B and flexure 608 may be an accordion shaped such that when deflected the flexure spreads out proximally as the shuttle 604 is pulled to the proximal end. Flexure 610 may attach to distal section 628 of shuttle 604 at attachment point 618A and attach to frame 602 at attachment point 618B. Attachment 618A may be located proximally to attachment 618B and flexure 610 may be an accordion shaped such that when deflected the flexure spreads out proximally as the shuttle 604 is pulled to the proximal end. Flexure 612 may attach to distal section 628 of shuttle 604 at attachment point 620A and attach to frame 602 at attachment point 620B. Attachment 620A may be located proximally to attachment 620B and flexure 612 may be an accordion shaped such that when deflected the flexure spreads out proximally as the shuttle 604 is pulled to the proximal end.

Shuttle 604 may include plunger 630 attached to a distal section 628 of shuttle 604. Since spring 600 may be implemented with something other than a projectile, as described above, plunger 630 may not be needed for spring 600 to function appropriately. Distal section 628 may attach to middle section 626 that may angle upwards towards proximal section 624 of shuttle 604 where it attaches to proximal section 624. Proximal section 624 of shuttle 604 may include hook 644 sized to attach to latch 642. At the proximal end of proximal section 624 may be grip 622. Grip 622 may provide a place where input force can be applied and can take the form of various connectors known in the art. Once an input force is applied to grip 622 pulling shuttle 604 proximally, hook 644 may interact with latch 642 locking shuttle 604 into a displaced position, as seen in FIGS. 2B and 4B. Flexures 606, 608, 610, and 612 may also be placed in a deflected position when shuttle 604 is locked into a displaced position. Shuttle 604 may be unlocked by pressure being applied to release 632. Release 632 may be attached to one or more flexures 634 and 636. Vertical release flexures 634 may be positioned at an angle respective to each other. Vertical release flexures 634 may facilitate the proximal and distal movement of release 632 such that the lower portion of release 632 moves more than the upper portion of release 632. Horizontal release flexure 636 may facilitate up and down movement of release 632 allowing hook 644 to slide into a locking position as input force is placed on grip 622. Proximally to horizontal release flexures 636 and below grip 622 may be anchor 638. As part of frame 602, anchor 638 may be used to stabilize spring 600 to function in a particular direction. Anchor 638 is depicted as a handle but can be any item known in the art used to stabilize and direct the movement of spring 600. Alternatively, Spring 600 may be secured in place by various method know in the art including and not including anchor 638.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A device comprising:
a frame;
one or more flexures attached to the frame;
a shuttle;
one or more of the one or more flexures attached to the shuttle; and
wherein the frame, the shuttle, and the one or more flexures are formed as a single piece.

2. The device of claim 1 where in the shuttle further comprises:
one or more vertical sections.

3. The device of claim 2, wherein one of the one or more vertical sections differs in length as compared to another vertical section.

4. The device of claim 2, wherein one of the one or more vertical sections are disposed at an angle from the length of the shuttle.

5. The device of claim 1, wherein the one or more flexures includes proximal flexures.

6. The device of claim 5 wherein the one or more flexures includes middle flexures.

7. The device of claim 5, wherein the one or more flexures includes distal flexures.

8. The device of claim 7, wherein the number of flexures include in the proximal flexures differs from the number flexures in the middle flexure.

9. The device of claim 7, wherein the combined number of distal flexures and proximal flexures is equal to the number of middle flexures.

10. The device of claim 6, wherein the angle of the proximal flexures differs from the angle of the middle flexures.

11. The device of claim 1, wherein the shuttle further comprises:
a hook.

12. The device of claim 11, further comprises:
a release.

13. The device of claim 12, wherein the release further comprises:
a latch.

14. The device of claim 13, wherein the hook of the shuttle and the latch of the release are sized to interact to lock the device into a deflected state.

15. The device of claim 12, wherein the latch is attached to one or more flexures.

16. The device of claim 15, wherein on of the one or more flexures is positioned horizontally.

17. The device of claim 15, wherein one of the one or more flexures is positioned vertically.

18. The device of claim 17, wherein the one of the one or more flexure positioned vertically is positioned vertically at an angle.

19. The device of claim 1, further comprises:
an anchor.

20. The device of claim 1, further comprises:
a grip.
